(19) United States
(12) Patent Application Publication
(10) Pub. No.: US 2011/0010670 A1
(43) Pub. Date: Jan. 13, 2011

(54) METHOD AND SYSTEM FOR RECOMMENDING ARTICLES

(76) Inventors: Julian PAAS, Mississauga (CA); Pendar YOUSEFI, Toronto (CA)

Correspondence Address: VENABLE LLP, P.O. BOX 34385, WASHINGTON, DC, 20043-9998, US

(21) Appl. No.: 12/558,132

(22) Filed: Sep. 11, 2009

Related U.S. Application Data
(63) Continuation-in-part of application No. 12/501,221, filed on Jul. 10, 2009.

(51) Int. Cl. G06N 5/02; G06F 3/048

(52) U.S. Cl. 715/825; 706/11; 706/46

(57) ABSTRACT

A system and method for recommending on-line articles and documents to users is disclosed. The system provides recommendations for articles with a display including at least one view showing a plurality of data items regarding one or more articles, an input device, a receiver module for receiving information regarding one or more articles, and a processor module, for determining replacement information to be displayed, based on the user input. The system may include a plurality of views and a changer module to switch between the views. The plurality of views includes a text view where the one or more articles are presented in a list and a grid view where the plurality of items are presented in a grid. A computer-implemented method of providing recommendations for articles is also disclosed.

### CROSS-REFERENCE TO RELATED APPLICATIONS

This application is a continuation-in-part of U.S. patent application Ser. No. 12/501,221, filed Jul. 10, 2009, now pending, entitled “METHOD AND SYSTEM FOR RECOMMENDING ARTICLES,” the subject matter of which is incorporated herein by reference in its entirety.

### FIELD

The present invention relates to an on-line method and system for recommending articles to users, based on user input.

### BACKGROUND

A recommender system recommends articles to a user. In this patent application, “article” means any content, data or material that can be delivered on-line, and includes but is not limited to text, such as newspaper or magazine articles, books and book chapters, advertisements, videos, PowerPoints, audio files, podcasts, images, blogs, tweets, or products or services which could be provided or purchased.

A weaknesses of current recommender systems for on-line articles may be that current on-line recommendation systems for articles have a number of disadvantages and present a number of problems.

One disadvantage may be that (a) current recommender systems do not relate user input to recommendations in a visible and real-time (or near real-time) way. Currently available systems do little to promote engagement by the user. Typically the user is asked to provide user input in relation to an article, but there is no immediate connection between that input and the resulting recommendations. Also, users typically have no other choices to specify the kinds of content that they wish to have recommended. The user doesn't have fun in interacting with the system and receiving recommendations from it. As well, the user often has only a limited understanding about why particular recommendations are being made. Because the user cannot see how his or her input immediately influences the recommendation or selection of articles, the user may have reduced acceptance of, and confidence in, the recommender system. As well, many current systems are relatively impersonal—they simply tell a visitor that “people who read this article also read ______”, or “people who read this article bought ______”. They do not appear to be personalized to a great extent.

In many previous recommender systems, recommendations may only be generated between on-line sessions, and presented the next time the user logs on to the system. This decreases user engagement, fun and confidence in the system.

Another disadvantage may be (b) sparsely rated content. Where the number of articles and users are increasing or changing quickly, then there may be relatively few articles rated, and relatively few users providing ratings for any particular article. It can be challenging to provide effective and reliable recommendations for such sparsely rated content.

A goal of the present application may be to address one or more the above-noted disadvantages and weaknesses of current recommender systems.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention is directed to a computer-implemented system and method of recommending articles, based on input from a user.

In one embodiment of the present invention, there is provided a computer-implemented system for providing recommendations for articles comprising: a display including at least one view showing a plurality of data items regarding one or more articles; an input device; a receiver module for receiving information regarding one or more articles; and a processor module, for determining replacement information to be displayed, based on the user input. The system may comprise a plurality of views and a changer module to switch between the views. The plurality of views may include a text view where the data items regarding one or more articles are presented in a list, and where, the plurality of data items includes a title and a date. The plurality of views may include a grid view where the one or more data items regarding one or more articles are presented in a grid and where, the plurality of data items includes a title, a date, and an image.

In a further embodiment of the present invention, the changer module includes a default view chosen from the plurality of views.

In a further embodiment of the present invention, the changer module may include a memory of the user's preferred view.

In a further embodiment of the present invention, the system further comprises a storage device for storing an article identifier for identifying an article, a user identifier for identifying a user, and a rating of the user for the article.

In a further embodiment of the present invention, the processor module determines a similarity between information presented in relation to the articles, and then determines the replacement information based on this similarity.

In a further embodiment, the invention provides a computer-implemented method of providing recommendations for articles, comprising the steps: receiving information regarding one or more articles; displaying a first subset of data items relating to said one or more articles, according to a first view, on a display device; responsive to a selection from the user, displaying a second subset of data items relating to the one or more articles, according to a second view, on the display device; receiving input from a user relating to the one or more articles, from an input device; and displaying a set of data items relating to more new articles based on the user input.

In a further embodiment of the invention, input received from the user is a rating of an article. In a further embodiment of the invention, the displaying the set of data items relating to more new articles is determined by the further following steps: determining an article rated favourably by the user; determining an article similar to an article rated favourably by the user on a computer processor; and, displaying a set of data items relating to the similar article.

In a further embodiment of the present invention, the step of determining an article similar to the article rated favourably by the user comprises the steps of: determining the frequency of words found in the article; determining the frequency of words found in a second article; determining with a computer processor a similarity metric based on the frequency of words found in article and the second article; and selecting a second article which meets a criteria to be the article similar to the article rated favourably by the user.

In a further embodiment of the present invention, the similarity metric is a cosine similarity metric.

In a further embodiment of the present invention, the criteria is the greatest value of the similarity metric.

In a further embodiment of the present invention, the criteria is a exceeding a threshold level.

In a further embodiment of the present invention, stop words in the article are not considered.

In a further embodiment of the present invention, the words in the article are stemmed.

In a further embodiment of the present invention, the method further comprises the steps: receiving input from the user indicating that the user wishes to see a different article; and removing the set of data items about an article.

In a further embodiment of the present invention, the first view is a list. In a further embodiment, the second view is a grid. In a further embodiment, the first subset of data items includes a title and a date. In a further embodiment, the second subset of data items includes a title, a date, and an image.

### BRIEF DESCRIPTION OF THE DRAWINGS

The present invention will be more readily understood from the following detailed description when read in conjunction with the accompanying drawings, in which:

FIG. 1 shows a user interface in accordance with an embodiment of the present invention;

FIG. 2 shows a flow chart in accordance with an embodiment of the present invention;

FIG. 3 shows a block diagram in accordance with an embodiment of the present invention;

FIG. 4 shows a schematic computer system in accordance with an embodiment of the present invention;

FIG. 5 shows a block diagram of a computer system in accordance with an embodiment of the present invention;

FIG. 6 is a screenshot showing a user interface in accordance with an alternative embodiment of the present invention, in grid view;

FIG. 7 is a screenshot of the user interface of FIG. 6, in expanded grid view;

FIG. 8 is a screenshot of the user interface of FIG. 6, in text view; and

FIG. 9 is a screenshot of the user interface of FIG. 6, in expanded text view.

### DETAILED DESCRIPTION

It is a goal of the present invention to provide one or more of the following features or benefits:
(a) promote engagement by the user;
(b) promote increased acceptance of the recommender system;
(c) provide a recommender system which engenders greater user confidence;
(d) provide a recommender system that provides more immediate connection between user input and resulting recommendations;
(e) provide a recommender system that is more enjoyable and fun for the user;
(f) provide a recommender system that can recommend articles even when relatively few users have provided input on an article;
(g) provide a recommender system that increases page views of articles by users;
(h) recommends to users more of the kinds of articles that they like, and less of the ones that they don't like; and,
(i) provide a recommender system that increases time spent by users viewing articles.

As used in this application, the terms “step”, “module”, “component”, “model”, “system”, and the like are intended to refer to a computer-related entity, either hardware, a combination of hardware and software, software, or software in execution. For example, a module may be, but is not limited to being, a process running on a processor, a processor, an object, an executable, a thread of execution, a program, and/or a computer. By way of illustration, both an application running on a server and the server can be a module. One or more modules may reside within a process and/or thread of execution and a module may be localized on one computer and/or distributed between two or more computers. Also, these modules can execute from various computer readable media having various data structures stored thereon. The modules may communicate via local and/or remote processes such as in accordance with a signal having one or more data packets (e.g., data from one module interacting with another module in a local system, distributed system, and/or across a network such as the Internet with other systems via the signal).

The present invention is directed to a computer-implemented system and method interacting with users, and more specifically, for recommending on-line articles to users.

The system and method for recommending on-line articles or documents is suited for any computation environment. It may run in the background of a general purpose computer. In one aspect, it has CLI (command line interface), however, it could also be implemented with a GUI (graphical user interface) or together with the operation of a web browser.

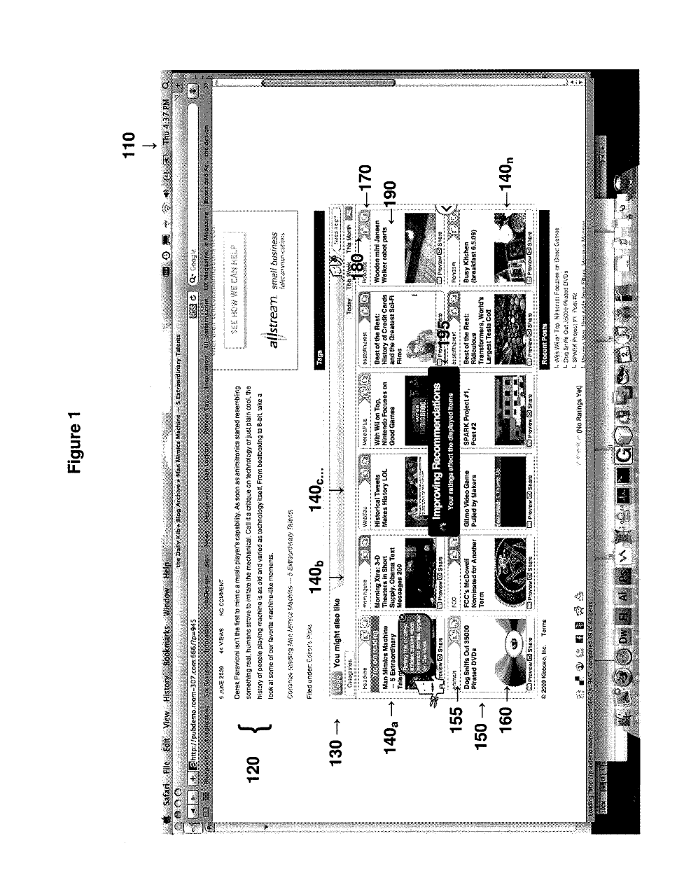

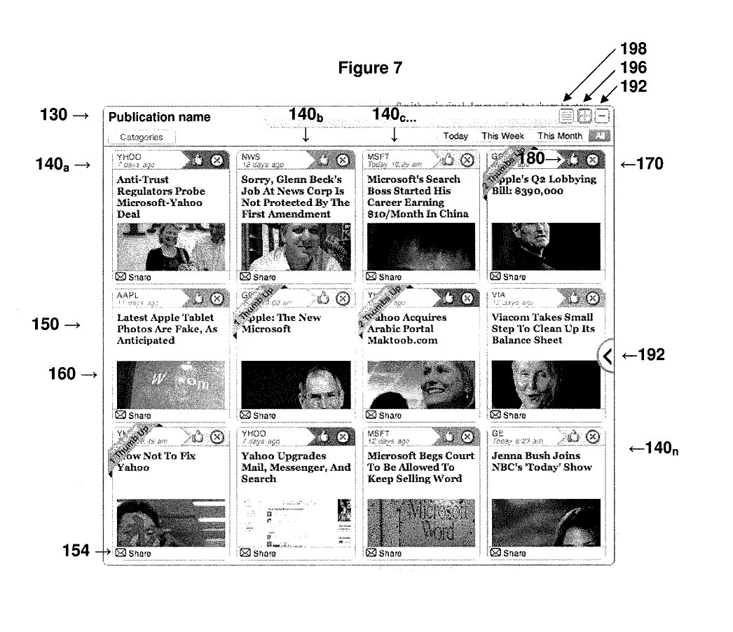

In an embodiment of the present invention, as is shown in FIG. 1, a user (not shown) views a display 110. The display, in an embodiment shows an article or portion of an article currently being read, viewed or listened to 120. Also shown is a user recommendation widget 130. User recommendation widget 130 provides or displays information about one or more articles 140ₐ . . . 140ₙ that may be of interest to the user. In an embodiment, the first article, 140ₐ, is the current article 120. The information (also referred to as data items) about articles 140ₐ . . . 140ₙ may include a title 150, an image 160, or further text relating to the article (not shown). Associated with each article 140ₐ . . . 140ₙ may also be a label 155 which provides a category of the related article, such as “animals”, “current events”, “news”, “sports”, or provides further information about the article. Associated with each article 140ₐ . . . 140ₙ may be an on-line button 170 to facilitate receiving user input on the displayed article 140ₐ . . . 140ₙ. With reference to FIG. 7, associated with each article 140ₐ . . . 140ₙ may also be a share button 154 to facilitate sharing the article by email or via another web service. As is shown in FIG. 1, on-line button 170 comprises, in an embodiment, a thumbs-up icon 180 and thumbs-down 190 icon. By clicking on the thumbs-up icon the user signals that they are favourably disposed towards the related article. Similarly, by clicking on the thumbs-down icon, the user signals that they are not favourably disposed towards the related article. User recommendation widget 130 may also contain a region 195 for display of further messages to the user. Alternatively, these further messages may be overlaid over the information about articles 140ₐ . . . 140ₙ.

It has been discovered that user engagement may be increased if more articles are presented to the user. As such, there is a need to allow the user to view more articles 140ₐ . . . 140ₙ on the display 130 via the user recommendation widget 130. However, the display 110 or user recommendation widget 130 (or both) typically have size restrictions, and as such, there is a trade-off as to the number of articles 140ₐ . . . 140ₙ that may be presented versus the information about articles 140ₐ . . . 140ₙ that may be presented to the user.

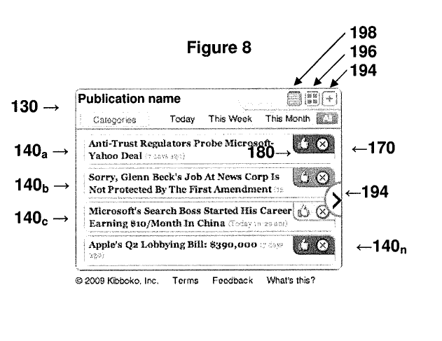

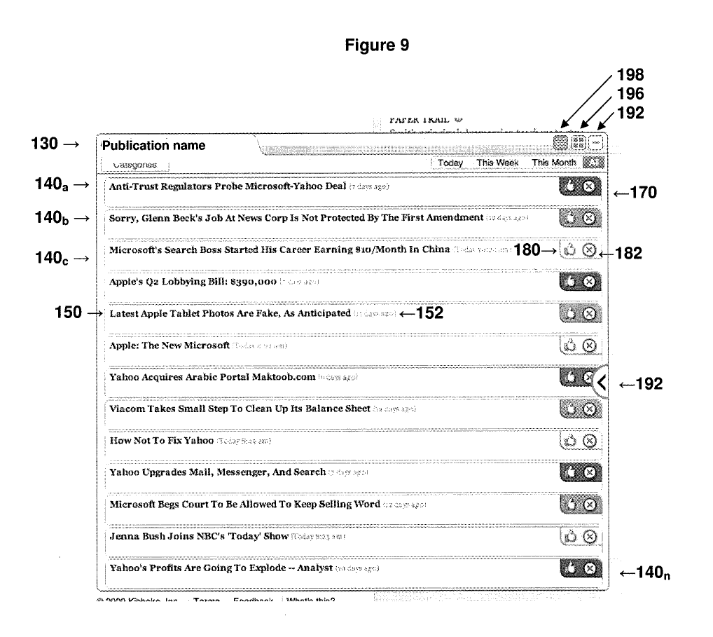

It has been discovered that some content is more suited for either a “grid view” presentation (as shown in FIG. 1, 6 or 7) or a “text view” presentation (as shown in FIG. 8 or 9). As described in the following paragraphs, although the “grid view” presentation is informative, the “text view” presentation which presents a list with a greater number of recommended articles may lead to better user satisfaction, usage, likelihood of accessing articles, etc.

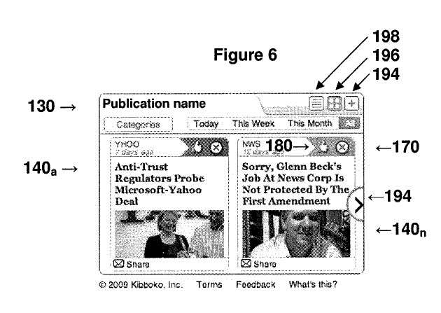

According to one aspect of the present invention, and as shown in FIGS. 6 and 7, the user recommendation widget 130 is shown as having a “grid view” presentation. The “grid view” presentation may be suitable for articles or content that consists of an image, that includes an image or that can be represented with an image.

One or more maximize buttons 194 may be provided to increase the working area of the user recommendation widget 130 (the expanded and unexpanded views are shown in FIGS. 6 and 8, and 7 and 9, respectively). The expanded (FIGS. 6 and 8) and unexpanded (FIGS. 7 and 9) views are an additional feature to overcome the problem of display and widget space limitations. One or more corresponding minimize buttons may be provided to reduce the working area of the user recommendation widget 130.

Optionally, a grid view button 196 and a text view button 198 may be provided to permit the user to select from either a “grid view” presentation or a “text view” presentation, which is described in more detail below.

According to another aspect of the present invention, and as shown in FIGS. 8 and 9, the user recommendation widget 130 is shown as having a “text view” presentation. Such a view gives the user recommendation widget 130 an alternative presentation that may better suit the nature of certain articles or content. For example, publications such as the New York Review of Books, the New Yorker or Foreign Affairs have relatively few images associated with the text of each article. As shown in FIGS. 8 and 9, the information about such articles 140ₐ . . . 140ₙ may include a title 150, a date 152 (or an article age, etc.), or further text relating to the article (not shown). Moreover, the information may also include a small image, for example, a thumbnail image (not shown). Optionally, the user may click on or hover on the thumbnail image to see a larger image (not shown). Associated with each article 140ₐ . . . 140ₙ may be an on-line button 170 to facilitate receiving user input on the displayed article 140ₐ . . . 140ₙ. As is shown in FIGS. 8 and 9, on-line button 170 comprises, in an embodiment, a thumbs-up icon 180 and a close icon 182. By clicking on the thumbs-up icon 180 the user signals that they are favourably disposed towards the related article. Similarly, by clicking on the close icon 182, the user signals that they are not favourably disposed towards the related article. User recommendation widget 130 may also contain a region 195 for display of further messages to the user. Alternatively, these further messages may be overlaid over the information about articles 140ₐ . . . 140ₙ.

Although two types of presentations have been described in considerable detail, namely the “grid view” and “text view” presentations, the skilled reader will appreciate that other types of views fall within the scope of this patent. For example, additional views could include but are not limited to, showing just a thumbnail images (image view), showing additional details such as an article summary (detailed view), showing a flip style view (coverflow view), showing article titles with varying sizes depending on which ones are recommended the most (cloud view). If additional presentation views are available, then the skilled reader will appreciate that user interface elements such as toggles, sliders, or buttons may be used to select a current view or cycle between the views, etc.

Still with reference to FIGS. 6-9, a further feature of the invention is to give publishers who host the user recommendation widget 130 the option of selecting a default view for the presentation (not shown) Moreover, the user recommendation widget 130 may include a “memory” to remember the preference of the user for the default view, which may be stored as a cookie on the user's computer system.

The information about articles 140ₐ . . . 140ₙ is stored in a database. A subset (e.g. selected portions) of the information is displayed according to default view, or the view selected (e.g. as selected by the buttons 196 or 198). The selected or default view is stored as a variable (not shown). The variable determines which view mode the current displayed articles (or items) have, and renders each article according to that view mode. When the user recommendation widget 130 first loads, the variable is populated by the default view mode that is set for all articles. If the user changes the view mode, then the variable may be overwritten by the newly selected mode.

The user recommendation widget 130 evaluates whether the selected view (e.g. whether it is a “grid view” according to button 196 or “text view” according to button 198), accesses the database to query the portion of information that should be displayed and then sends the result of the query data to display the portion of information on the selected view.

Articles 140ₐ . . . 140ₙ may comprise articles that are frequently viewed, listened to or read. They may also comprise articles that are new or more recent. In an embodiment, the user may apply one or more filters (via a user interface which is not shown). These filters could select categories of articles a user is interested in, for example, only sports-related articles or no sports-related articles.

An important aspect of the present invention is that upon receiving input from the user on one or more of articles 140ₐ to 140ₙ the system and method, in the same session, provides one or more new (refreshed or replacement) articles to the user in place of one or more articles 140ₐ to 140ₙ. For example, in an embodiment, where a user gives a thumbs-up to one or more of articles 140ₐ to 140ₙ the system and method will replace one or more articles 140ₐ to 140ₙ which a new article based on this user input. Similarly, in an embodiment, where a user gives a thumbs-down to one or more of articles 140ₐ to 140ₙ, the system and method will replace one or more of articles 140ₐ to 140ₙ with a new article based on this user input. In an embodiment, where the user gives a thumbs-up, one or more replacement articles are provided which are similar to the article given the thumbs-up.

Where an article is given a thumbs-down, one or more replacement articles are provided which are similar to an article previously given a thumbs-up. In an embodiment, after an article is rated (given a thumbs-up or thumbs-down), it remains displayed until the user clicks on a related button or icon containing text such as “show another article”.

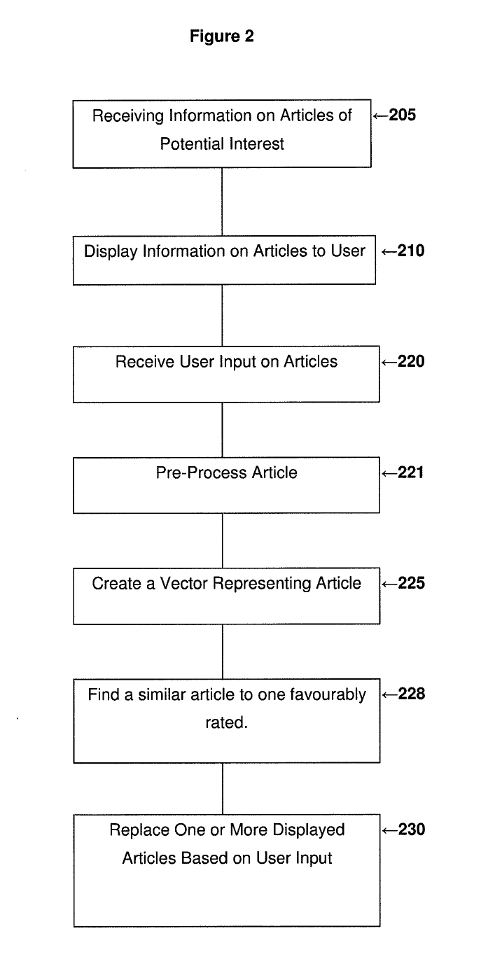

FIG. 2 provides a flow chart showing an embodiment of the present invention.

In step 205, information is received regarding articles of possible interest.

In step 210, information on articles of possible interest are displayed to a user.

In step 220, input is received from the user on one or more of the displayed articles. In an embodiment of the present invention, this input is a click (via a mouse or other input device) on a thumbs-up or thumbs-down icon.

In step 230, one or more of the displayed articles (or information about them) is replaced, based on the user input. Typically, a new article or articles would be provided.

As mentioned above, in an embodiment, when a user provides a thumbs-up, one or more similar articles are provided in user recommendation widget 130. These replace articles originally displayed in widget 130. In an embodiment, a portion of articles 140ₐ to 140ₙ are used for this purpose.

The document receiving the thumbs-up may optionally be pre-processed in step 221. The data pre-processing 221 may comprise stop-word deletion, stemming and title and link extraction, which transforms or presents each article as a document vector in a bag-of-words data structure. With stop-word deletion, selected “stop” words (i.e. words such an “an”, “the”, “they” that are very frequent and do not have discriminating power) are excluded. The list of stop-words can be customized. Stemming converts words to the root form, in order to define words that are in the same context with the same term and consequently to reduce dimensionality. Such words may be stemmed by using Porter's Stemming Algorithm but other stemming algorithms could also be used. Text in links and titles from web pages can also be extracted and included in a document vector.

For each document, in step 225 of the invention a vector is created, setting out the frequency of occurrence of each of the words found in the article. In other words for each article of interest a vector is created {F₁, F₂, . . . F_{X}}, where F₁ represents the frequency in the document of the word, W₁. Where a word is not found in the article, the frequency is zero.

In another embodiment, the vector may only be created for a portion of the article, such as the title and first paragraph, or for a brief description or abstract of it.

Vectors are then created using the same words, to represent other potentially similar articles. Then the vectors are compared in step 228 to determine those most similar. In another embodiment, cosine similarity may be used to compare the two article vectors.

For example:

| | Article 1 words: | | | | |
|---|---|---|---|---|---|
| | W₁, | W₂, | W₃, | W₄ . . . | Wₙ |
| # of occurrences | 6, | 3, | 2, | 1, . . . | 1 |
| Article 2 # of | 3, | 0, | 1, | 0, . . . | 0 |
| occurrences | | | | | |

$$Similarity = \frac{\begin{matrix}\sum \# of occurrences {W}_{n} in article 1 \times \\ \# of occurrences of {W}_{n} in article 2\end{matrix} }{\sqrt{{W}_{n}^{2} in Article 1} \times \sqrt{{W}_{n}^{2} in Article 2}}$$

For example:

$$Similarity = \frac{6 \cdot 3 + 3 \cdot 0 + 2 \cdot 1 + 1 \cdot 0 … + 1 \cdot 0}{\sqrt{{6}^{2} + {3}^{2} + {2}^{2} + {1}^{2} … {1}^{2}} \cdot \sqrt{{3}^{2} + {0}^{2} + {1}^{2} + {0}^{2} … {0}^{2}}}$$

Other measures of similarity are also possible for example:

(a) Sørensen's quotient of similarity

(b) Mountford's index of similarity

(c) Hamming distance

(d) Correlation

(e) Dice's coefficient

(f) Jaccard index

(g) SimRank

(h) Information retrieval

(i) Weighted cosine measure

In another embodiment, the publisher of articles, such as a newspaper publisher, provides the information which is received in step 205. In another embodiment, this is provided via an extension to the RSS feed version 2.0. For each article, the publisher may provide the following information:

(a) article title;

(b) article URL;

(c) article text;

(d) article category;

(e) the URL of a thumbnail image;

(f) article ID; and,

(g) a final date of publication.

In another embodiment, articles (or information about them) are not displayed after the final date of publication received from the publisher.

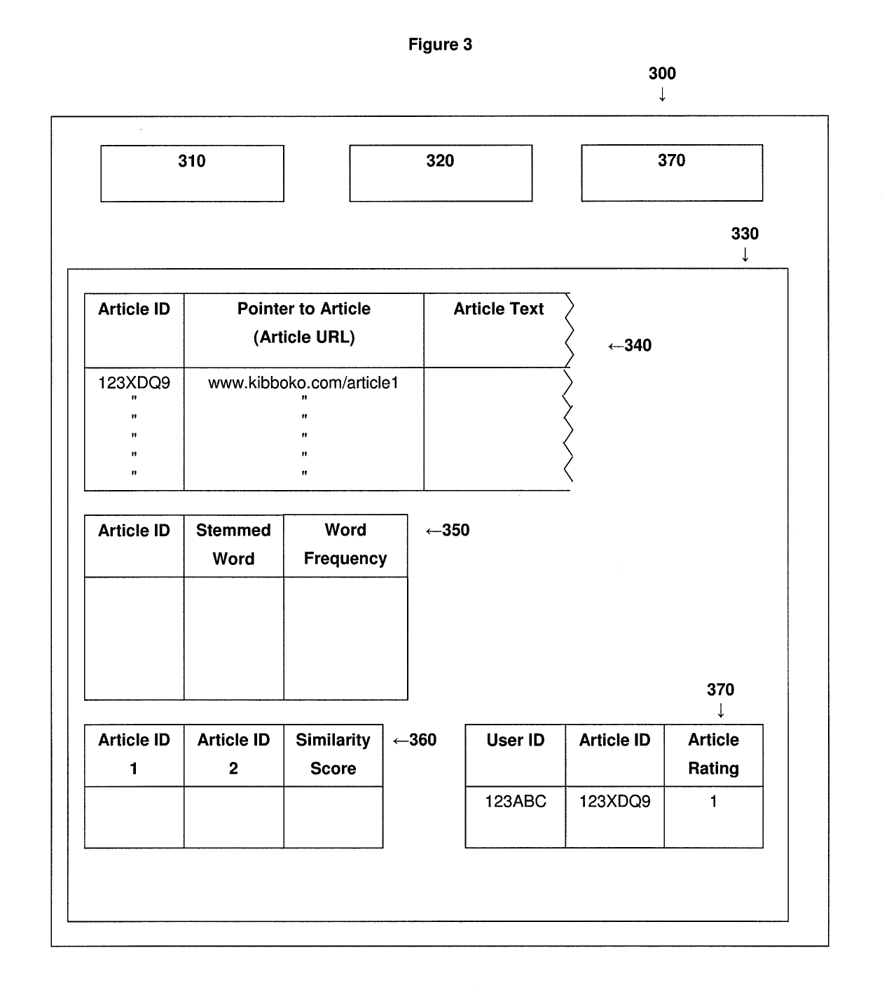

Further information on the RSS specification can be found at http://cyber.law.harvard.edu/rss/rss.html. In another embodiment, the information from this RSS feed is stored on table 340 as partially shown in FIG. 3. Alternatively, this information can be received in various other ways, including via spreadsheets or can be acquired by web robots.

In another embodiment, related to each article is a table, stored in a database, which stores stemmed words and the associated word count for each article. This is shown in FIG. 3.

FIG. 3 shows a recommender system 300, which contains a display 310 and user input device 320. Recommender system 300 also contains a database 330 with a number of tables, such as table 340 which is described above. Database 330 also contains table 350 which provides for each article ID, a list of stemmed words and the frequency each stemmed word appears in the article identified word.

In another embodiment, each user is given a unique user ID, which is stored as a cookie on the user's computer system. Database 330 also contains a table 370, which sets out information such as the user ID, article ID, and the input or rating received on the article.

In another embodiment, database 330 also contains a table which stores the IDs for first and second articles and the associated similarity score.

The format of tables described as occurring in database 330 are exemplary only—other formats are possible and within the scope of the present invention.

Recommender system 300 also contains a CPU 370 for calculating similarity scores and for carrying out other tasks.

When a user gives one or more of articles 140ₐ . . . 140ₙ a less favourable rating, for example, a thumbs-down, the system then checks table 370 and determines a previous article given a more favourable rating. One or more articles (or information about them) similar to a previously favourably rated article is then displayed to the user. The displayed articles will be ones meeting a specified criteria. The most similar article or articles may be displayed as replacement articles. Alternatively, articles exceeding a threshold level of the similarity metric may be displayed.

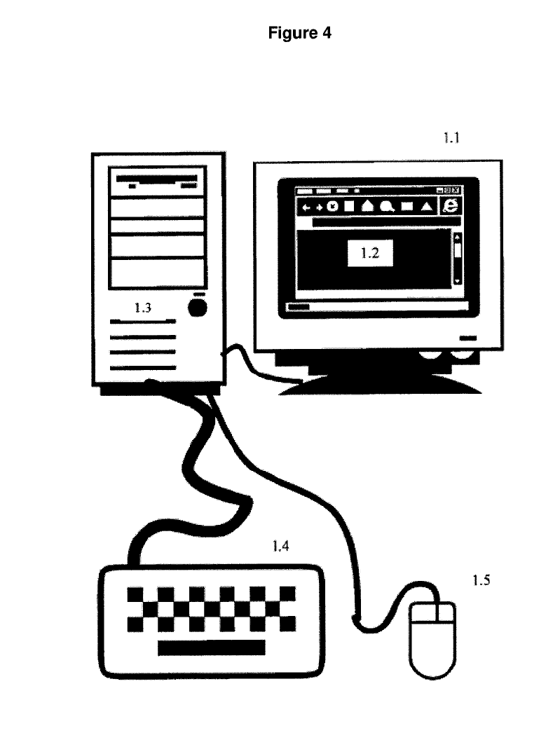

FIG. 4 shows a general computer system on which the invention might be practiced. The general computer system comprises of a display device (1.1) with a display screen (1.2). Examples of display device are Cathode Ray Tube (CRT) devices, Liquid Crystal Display (LCD) Devices etc. The general computer system can also have other additional output devices like a printer. The cabinet (1.3) houses the additional basic components of the general computer system such as the microprocessor, memory and disk drives. In a general computer system the microprocessor is any commercially available processor of which x86 processors from Intel and 680X0 series from Motorola are examples. Many other microprocessors are available. The general computer system could be a single processor system or may use two or more processors on a single system or over a network. The microprocessor for its functioning uses a volatile memory that is a random access memory such as dynamic random access memory (DRAM) or static memory (SRAM). The disk drives are the permanent storage medium used by the general computer system. This permanent storage could be a magnetic disk, a flash memory and a tape. This storage could be removable like a floppy disk or permanent such as a hard disk. Besides this the cabinet (1.3) can also house other additional components like a Compact Disc Read Only Memory (CD-ROM) drive, sound card, video card etc. The general computer system also had various input devices like a keyboard (1.4) and a mouse (1.5). The keyboard and the mouse are connected to the general computer system through wired or wireless links. The mouse (1.5) could be a two-button mouse, three-button mouse or a scroll mouse. Besides the said input devices there could be other input devices like a light pen, a track ball, etc. The microprocessor executes a program called the operating system for the basic functioning of the general computer system. The examples of operating systems are UNIX™, WINDOWS™ and OS X™. These operating systems allocate the computer system resources to various programs and help the users to interact with the system. It should be understood that the invention is not limited to any particular hardware comprising the computer system or the software running on it.

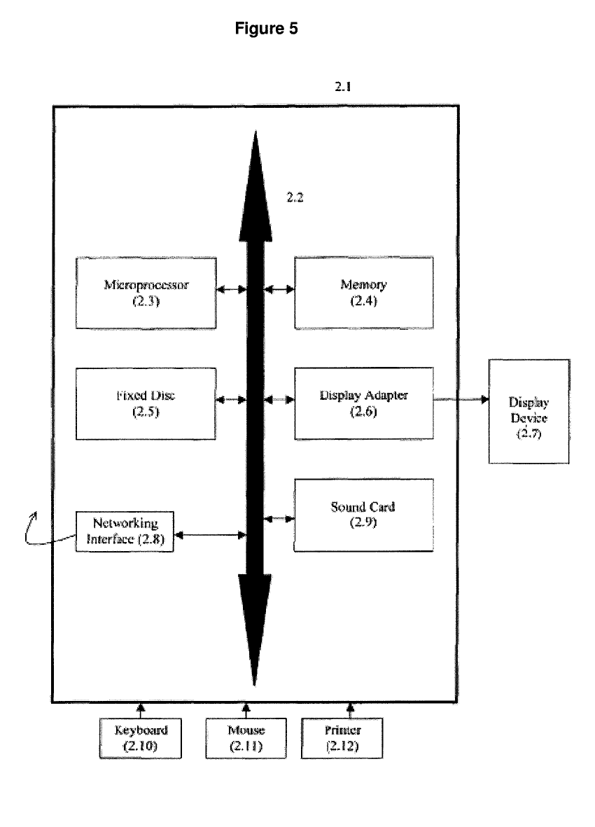

FIG. 5 shows the internal structure of the general computer system of FIG. 5. The general computer system (2.1) consists of various subsystems interconnected with the help of a system bus (2.2). The microprocessor (2.3) communicates and controls the functioning of other subsystems. Memory (2.4) helps the microprocessor in its functioning by storing instructions and data during its execution. Fixed Drive (2.5) is used to hold the data and instructions permanent in nature like the operating system and other programs. Display adapter (2.6) is used as an interface between the system bus and the display device (2.7), which is generally a monitor. The network interface (2.8) is used to connect the computer with other computers on a network through wired or wireless means. The system is connected to various input devices like keyboard (2.10) and mouse (2.11) and output devices like printer (2.12). Various configurations of these subsystems are possible. It should also be noted that a system implementing the present invention might use less or more number of the subsystems than described above. The computer screen which displays the recommendation results can also be a separate computer system than that which contains components such as database 360 and the other modules described above.

In another embodiment, the computer system will include a receiver module for receiving information regarding one or more articles. The system will also include a processor module, for determining replacement information to be displayed, based on the user input. The system will also include a changer module, for switching between views to be displayed.

What has been described above includes examples of the present invention. It is, of course, not possible to describe every conceivable combination of components or methodologies for purposes of describing the present invention, but one of ordinary skill in the art may recognize that may further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It will be understood that the above description of the present invention is susceptible to various modifications, changes and adaptations, and the same are intended to be comprehended within the meaning and range of equivalents of the appended claims.

What is claimed is:

1. A computer-implemented system for providing recommendations for articles comprising:
a) a display including at least one view showing a plurality of data items regarding one or more articles;
b) an input device;
c) a receiver module for receiving information regarding the one or more articles; and
d) a processor module, for determining replacement information to be displayed, based on the user input.

2. The system of claim 1, further comprising: a storage device for storing an article identifier for identifying an article, a user identifier for identifying a user, and a rating of the user for the article.

3. The system of claim 1, wherein the processor module determines a similarity between information presented in relation to the articles, and then determines the replacement information based on this similarity.

4. The system of claim 1, further comprising: a plurality of views and a changer module to switch between the views.

5. The system of claim 4, wherein the plurality of views includes a text view where the data items regarding one or more articles are presented in a list.

6. The system of claim 5, wherein the plurality of data items includes a title and a date.

7. The system of claim 4, wherein the plurality of views includes a grid view where the one or more data items regarding one or more articles are presented in a grid.

8. The system of claim 7, wherein the plurality of data items includes a title, a date, and an image.

9. The system of claim 4, wherein the changer module includes a default view chosen from the plurality of views.

10. The system of claim 4, wherein the changer module includes a memory of the user's selected view.

11. A computer-implemented method of providing recommendations for articles, comprising the steps:
(a) receiving information regarding one or more articles;
(b) displaying a first subset of data items relating to the one or more articles, according to a first view, on a display device;
(c) responsive to a selection from the user, displaying a second subset of data items relating to the one or more articles, according to a second view, on the display device;
(d) receiving input from a user relating to the one or more articles, from an input device; and
(e) displaying a set of data items relating to more new articles based on the user input.

12. The method of claim 11, wherein the input received from the user is a rating of an article.

13. The method of claim 11, wherein displaying the set of data items relating to more new articles is determined by the further following steps:
(a) determining an article rated favourably by the user;
(b) determining an article similar to an article rated favourably by the user on a computer processor; and
(c) displaying a set of data items relating to the similar article.

14. The method of claim 13, wherein the step of determining an article similar to the article rated favourably by the user comprises the steps of:
(a) determining the frequency of words found in the article;
(b) determining the frequency of words found in a second article;
(c) determining a similarity metric based on the frequency of words found in article and the second article; and
(d) selecting a second article which meets a criteria to be the article similar to the article rated favourably by the user.

15. The method of claim 14, wherein the similarity metric is a cosine similarity metric.

16. The method of claim 14, wherein the criteria is the greatest value of the similarity metric.

17. The method of claim 14, wherein the criteria is a exceeding a threshold level.

18. The method of claim 14, wherein stop words in the article are not considered.

19. The method of claim 14, wherein the words in the article are stemmed.

20. The method of claim 13, further comprising the steps:
(a) receiving input from the user indicating that the user wishes to see a different article; and
(b) removing the set of data items about an article.

21. The method of claim 11, wherein the first view is a list.

22. The method of claim 21, wherein the second view is a grid.

23. The method of claim 22, wherein the first subset of data items includes a title and a date.

24. The method of claim 23, wherein the second subset of data items includes a title, a date, and an image.
